(19) United States
(12) Patent Application Publication
(10) Pub. No.: US 2021/0315418 A1
(43) Pub. Date: Oct. 14, 2021

(54) SYSTEM AND METHOD FOR IMPROVING THE COOKING OF FOODSTUFF FOR ROTISSERIE GRILLING APPLICATIONS

(71) Applicant: Align Machine Works, LLC, Athens, GA (US)

(72) Inventors: Joseph Pruitt, Athens, GA (US); Jeffrey Broadrick, Athens, GA (US); Kyle Aasness, Athens, GA (US)

(73) Assignee: Align Machine Works, LLC, Athens, GA (US)

(21) Appl. No.: 16/842,961

(22) Filed: Apr. 8, 2020

(51) Int. Cl. A47J 37/04

(52) U.S. Cl. CPC A47J 37/041

(57) ABSTRACT

Exemplary embodiments of a system and method for improving rotisserie grilling applications are disclosed. The system may include a support frame comprising at least one central shaft, a first side shaft, and a second side shaft. The system may also include a basket coupled to the two side shafts. The basket may comprise a locking device that couples to the first side shaft and a side shaft engagement mechanism that couples to the second side shaft. The basket may define a volume for receiving foodstuff. The side shaft engagement mechanism may comprise a clamp, such as clamp having a substantially c-shaped geometry. The support frame may further comprise a side shaft mounting unit that receives the one central shaft within a central portion of its geometry. The side shaft mounting unit may further comprise cylindrical shaped couplers for holding two side shafts relative to the central shaft.

### BACKGROUND

The present invention relates to outdoor grilling and/or smoking solutions and, more particularly, to a novel system and method for improving the cooking of foodstuff for grilling applications, and specifically, rotisserie grilling applications.

As known to grilling enthusiasts and others skilled in the culinary arts as of this writing, a rotisserie is also known as spit-roasting. It is a style of roasting where a foodstuff, usually some form of meat, is skewered on a spit. A spit is usually a long solid rod used to hold the foodstuff while it is being cooked over a fire in a fireplace or over a campfire, roasted in an oven, or roasted over a grill.

This well-known method of rotisserie cooking is generally used for cooking large portions of meat or entire animals even, including, but not limited to, pork, beef, fish, venison, or turkey, and/or other meats and foodstuffs. The rotation of the spit, where the foodstuff is pierced by the spit, cooks the foodstuff usually evenly in its own juices and allows easy access for continuous basting of the foodstuff.

Advantageously, grilling or smoking food held by a spit imparts desirable flavor to the foodstuff. Exemplary grills that may support a spit for rotisserie cooking include both kettle-styled grills as well as kamado-style cookers, as known to one of ordinary skill in the art.

One problem with a spit for rotisserie cooking is that the spit, or rod, may be challenging to penetrate through the foodstuff to be cooked. That is, it may be difficult to pierce certain types of foodstuffs, like meat, if the spit or rod is too thick or wide relative to the cross-section of the foodstuff being cooked. Also, sometimes, the foodstuff proximate to the spit or rod may not cook completely or evenly if the spit or rod has a different temperature compared to the environmental temperature that may be adjacent to the spit or rod, which is produced by a heat source that may include an open flame in either a kettle-styled grill or a kamado-style cooker. Spits are also notorious for “tearing up” delicate foodstuffs.

Some rotisserie systems may use baskets in combination with a spit to support a foodstuff over the heat source, especially a delicate foodstuff. One problem with conventional baskets is that the spit often penetrates through a central portion of the basket and may interfere with loading of foodstuff into the basket as well as damage the foodstuff during cooking.

Therefore, there is a need in the art for a system and method for improving the cooking of foodstuff for grilling applications where the spit or rod of a rotisserie may be removed or re-positioned such that foodstuff may be evenly cooked without being pierced by the spit or rod. Another need exists in the art for improving rotisserie baskets such that a spit does not penetrate thorough a volume formed by the basket.

### SUMMARY

Exemplary embodiments of a system and method for improving rotisserie grilling applications are disclosed. The system may include a support frame comprising at least one central shaft, a first side shaft, and a second side shaft. The system may also include a basket coupled to the two side shafts. The basket may comprise a locking device that couples to the first side shaft and a side shaft engagement mechanism that couples to the second side shaft. The basket may define a volume for receiving foodstuff.

The side shaft engagement mechanism may comprise a clamp, such as clamp having a substantially c-shaped geometry. The support frame may further comprise a side shaft mounting unit that receives the one central shaft within a central portion of its geometry.

The basket may be a first basket, and the system may further comprise a second basket that is positioned along the support frame adjacent to the first basket. The first and second baskets may have different geometries relative to each other. In other exemplary embodiments, the first and second baskets may have substantially identical geometries relative to each other.

Each basket may include an adjustable grating. In other embodiments, a basket may define a barrel-shape geometry. In other embodiments, the basket may have a wire-frame grating that is removable.

In other exemplary embodiments, the system may include a support frame and at least three baskets which can be mounted to the support frame. In some exemplary embodiments, a support frame may support two baskets and in other embodiments, the support frame may support three baskets. In other exemplary embodiments, the support frame may support a single basket depending upon the size of the support frame. The support frame may be designed to have one of two different sizes, usually which only vary along a length of the support frame (meaning that the width may remain the same between the two different sizes for the support frame).

The baskets and support frames may be sold in kits which include various, different combinations of the support frames and baskets. The support frame may be sold separate from the baskets and vice-versa.

Three types of baskets may form parts of the system. A first basket may have a single side wall and two gratings which are removable relative to the single side wall. A second basket may also have two gratings and a single side wall. However, the single side wall of the second basket may have adjustment grooves which support each of the gratings so that a position of each of the gratings may be adjusted relative to the side wall. A third basket may generally define a barrel-shape and it may comprise two clam-shell shapes, where one clam-shell may open relative to the other clam-shell.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 illustrates an exemplary embodiment of a system for improving the cooking of foodstuff for rotisserie grilling applications;

FIG. 2 illustrates an exemplary elevational, perspective close up view of the system of FIG. 1 in which the two baskets are in a first position;

FIG. 3 illustrates an exemplary elevational, perspective close up view of the system of FIG. 1 in which the two baskets have been rotated to a second position relative to the first position shown in FIG. 2;

FIG. 4 illustrates an exemplary elevational, perspective close up view of the two baskets and support frame without being attached/coupled to a grill;

FIG. 5 is an elevational, perspective view which illustrates three types of baskets which can be combined in various configurations along with two different types of support frames;

FIG. 6 illustrates an elevational view of a support frame without any baskets coupled to the structure;

FIG. 7 is an elevational, perspective view of the support frame of FIG. 6 according to one exemplary embodiment;

FIG. 8 illustrates a side view of the first side shaft mounting unit shown in FIG. 7;

FIG. 9 illustrates a side view of the second side shaft mounting unit shown in FIG. 7;

FIG. 10 illustrates an elevational, perspective view of the second type of basket which is presented in earlier FIGS. 1-5;

FIG. 11 illustrates an elevational, perspective view of the second type of basket also shown in FIG. 10, but with one of the gratings removed from the side walls;

FIG. 12, this figure illustrates a side view of the second type of basket shown in FIGS. 10-11;

FIG. 13 illustrates a side, perspective view of the second type of basket presented in FIGS. 1-5 and 10-12;

FIG. 14 illustrates a top view of a basket 102c of the third type as also shown in FIG. 5;

FIG. 15 illustrates a perspective, side view of the third basket that is illustrated in FIGS. 5 and 14;

FIG. 16 illustrates a side, perspective view of the third basket slightly rotated relative to the orientation illustrated in FIG. 15;

FIG. 17 illustrates a side, perspective view of the third basket where its top half/clam shell has been opened along the hinges, which were illustrated in FIG. 15;

FIG. 18 illustrates an elevational perspective view of three baskets of the first type which are also illustrated in FIG. 5;

FIG. 19 illustrates another perspective, elevational view of the three baskets of FIG. 18, where a grating of one basket has been opened; and

FIG. 20 illustrates a bottom, perspective view of the three baskets of the first type which have been slightly rotated along the central shaft relative to the position of the three baskets shown in FIG. 19.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

Various embodiments, aspects and features of the present invention encompass a system and method for improving rotisserie grilling applications. The system may include a support frame and at least three baskets that can be mounted to the support frame. In some exemplary embodiments, a support frame may support two baskets and in other embodiments, the support frame may support three baskets. In other exemplary embodiments, the support frame may support a single basket depending upon the size of the support frame. The support frame may be designed to have one of two different sizes, usually which only vary along a length of the support frame.

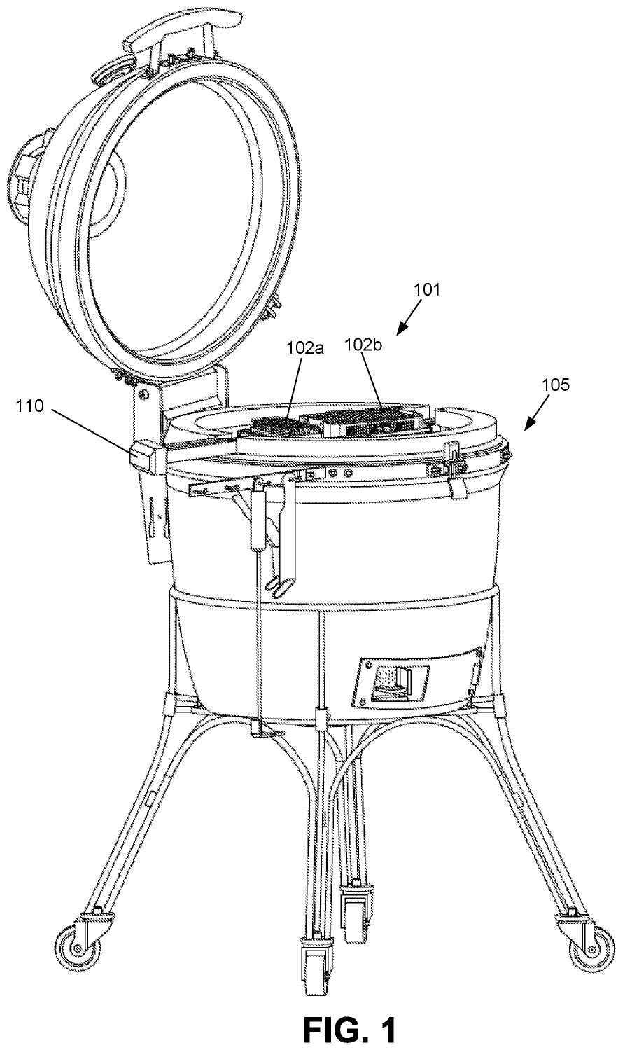

Referring now to FIG. 1, this figure illustrates an exemplary embodiment of a system 101 for improving the cooking of foodstuff for rotisserie grilling applications. The system 101 may comprise a grill 105, and two baskets 102a, 102b positioned above a heat source (not shown) for the grill 105. The grill 105 as shown may comprise a kamado-style grill and as understood by one of ordinary skill in the art. However, other types of grills 105 are possible and are included within the scope of this disclosure. Other type of grills 105, include, but are not limited to, kettle-styled grills, brazier grills, pellet grills, square charcoal grills, shichirin (hibachi) grills, charcoal cart grills, barrel grills, ceramic cookers, tandoor ovens, portable charcoal grills, and portable backpack grills, just to name a few.

The system 101 may further comprise a device or machine 110 for rotating the baskets 102. The machine 110 may comprise an electric motor or any other type of device or machine for rotating a rod or shaft, which in turn, rotates and turns the baskets 102. The machine or device 110 may be characterized as a means for rotating a shaft and/or the baskets 102. The machine or device 110 may be battery powered (i.e. by direct current—DC) or it can be powered by alternating current (AC) as understood by one of ordinary skill in the art.

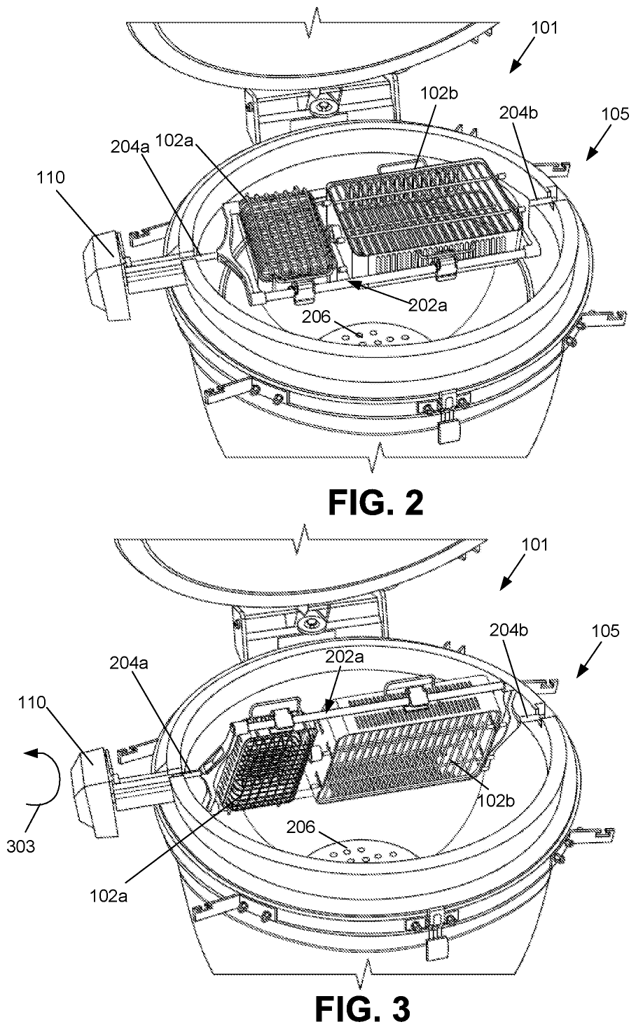

Referring now to FIG. 2, this figure illustrates an exemplary elevational, perspective close up view of the system 101 of FIG. 1 in which the two baskets 102a, 102b are in a first position. According to this exemplary embodiment, further details of each basket 102a, 102b are now visible. The two baskets 102a, 102b are supported by a frame 202a. The frame 202a may comprise a first central shaft 204a and a second central shaft 204b. The first central shaft 204a may be coupled to the rotating device 110 as described above. When the first central shaft 204a is rotated by the rotating device 110, this causes the entire frame 202a to rotate about the longitudinal axis defined by the first central shaft 204a and the second central shaft 204b.

As shown in FIG. 2, the frame 202a supports the two baskets 102a, 102b within a central region of the grill 105 and above a heat source (not shown, but usually includes a flame). The heat source may be positioned at a location 206 that is generally near a bottom section of the grill 105.

Referring now to FIG. 3, this figure illustrates an exemplary elevational, perspective close up view of the system 101 of FIG. 1 in which the two baskets 102a, 102b have been rotated to a second position relative to the first position shown in FIG. 2. Specifically, according to this exemplary embodiment, the two baskets 102a, 102b have been rotated about forty-five degrees by the rotating device 110 (as shown by rotational directional arrow 303) into a second position relative to the first position illustrated in FIG. 2. The rotating device 110 may rotate the first central shaft 204a at a constant speed. The speed of rotation may be adjusted as desired and depending on the desired amount of heating needed for foodstuffs (not shown) which are contained/enveloped by the each basket 102a, 102b.

The first basket 102a and second basket 102b may comprise wire framing for holding foodstuffs (not shown) within the volume defined by these wire frames. According to the illustrated exemplary embodiment, both baskets 102a, 102b may generally comprise a rectangular shape. However, other shapes are possible and are included within the scope of this disclosure. Other shapes include, but are not limited to, square, triangular, circular, pentagonal, hexagonal, octagonal, elliptical, and others, just to name a few.

According to this exemplary embodiment of FIG. 3, the first basket 102a may define a first volume, while the second basket 102b may define a second volume. The first volume may have a magnitude which is less than a magnitude for the second volume. According to the exemplary embodiment of FIG. 3, each basket 102a, 102b may share a common dimension, such as width dimension which is identical in magnitude so that the baskets 102a, 102b may grasp/contact the frame 202a. Meanwhile, other dimensions, such as length dimensions may have different magnitudes relative to each other which while be described in further detail below.

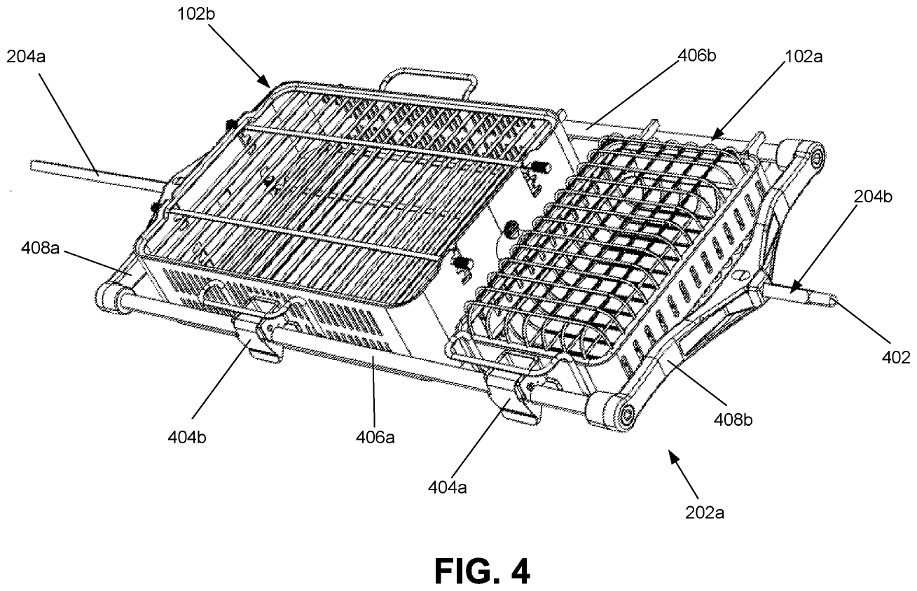

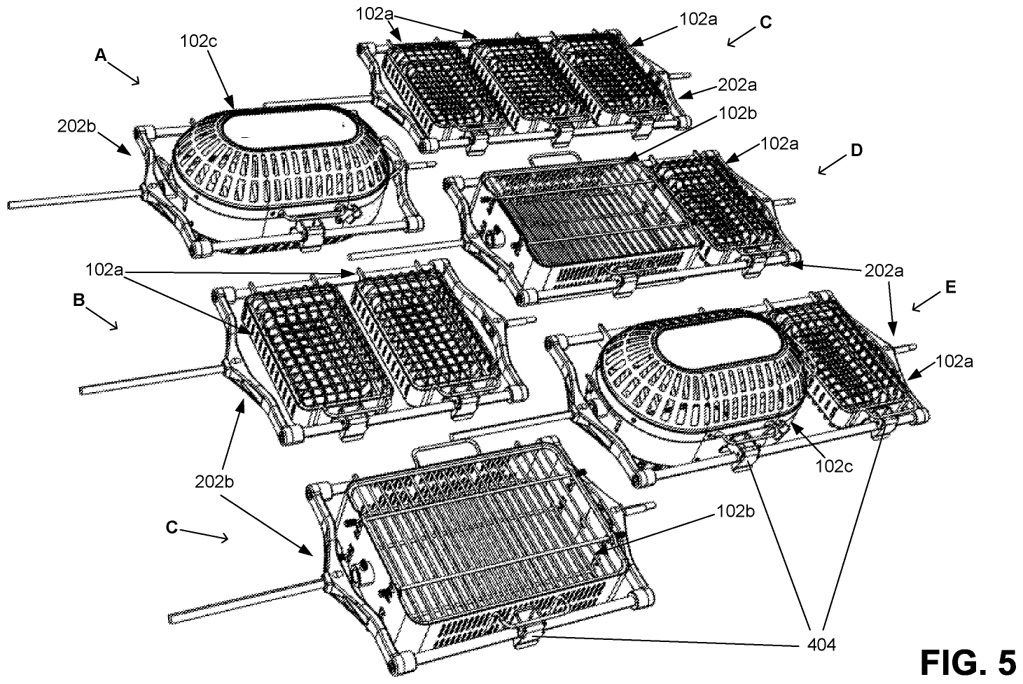

Referring now to FIG. 4, this figure illustrates an exemplary elevational, perspective close up view of the two baskets 102a, 102b and support frame 202a without being attached/coupled to a grill (not shown). According to this exemplary embodiment, the positions of the two baskets 102b, 102a have been reversed compared to FIG. 3. Meanwhile, the position of the support frame 202a remains the same compared to FIG. 3. That is, the support frame 202a of FIG. 4 has the same orientation as it is illustrated in FIG. 3.

The first central shaft 204a of the support frame may have a square shaped cross-section along its entire length. Meanwhile, the second central shaft 204b may have a square shaped cross-section for most of its length. However, the second central shaft 204b may have a shorter section 402 along its length which has a circular shaped cross-section as illustrated in FIG. 4.

The shorter section 402 of the second central shaft 204b with its circular shaped cross-section may facilitate smooth rotation with this geometry at its end. However, other cross-sectional shapes for the first and second central shafts 204a, 204b are possible and are included within the scope of this disclosure. Other shapes include, but are not limited to, elliptical, rectangular, pentagonal, and other polygonal shapes.

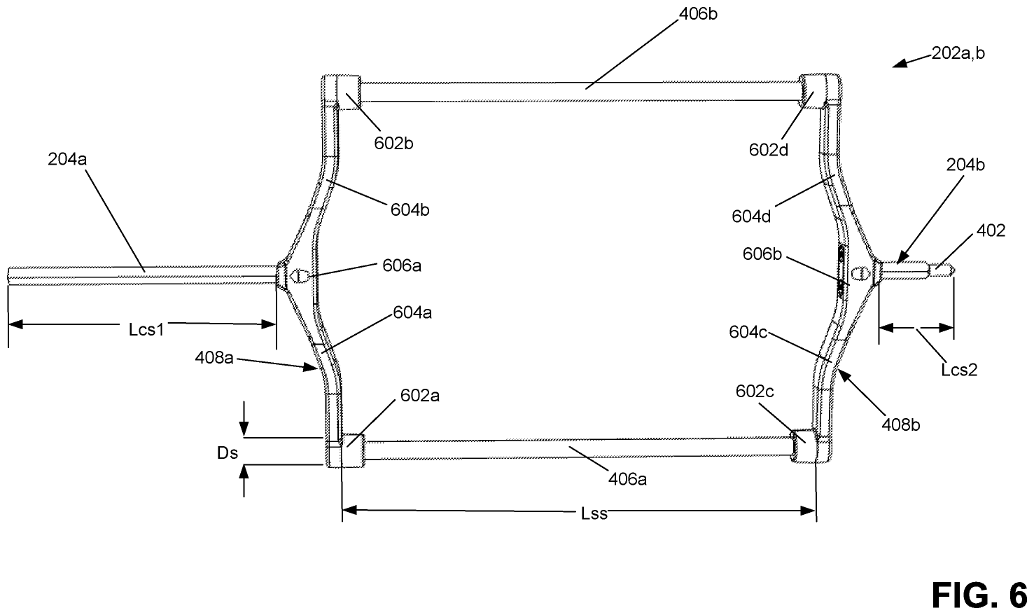

The support frame 202a may further comprise a pair of side shaft mounting units 408a, 408b. Each side shaft mounting unit 408 may comprise a prismatic member that is coupled at its ends to the first and second side shafts 406a, 406b. Each side shaft mounting unit 408 may further be coupled to at least one central shaft 204 at its approximate geometric center. Further details for each side shaft mounting unit 408 will be described below in connection with FIGS. 6-9.

Further details of each basket are now visible in this FIG. 4. Each basket 102a, 102b may have a locking device 404a, 404b for coupling each basket 102 to a side shaft 406a of the support frame 202a. This locking device 404 may comprise a clasp which may open and release the locking device 404 from the side shaft 406a of the support frame 202a as understood by one of ordinary skill in the art. Locking devices 404 other than those illustrated may be employed without departing from the scope of this disclosure.

The locking devices 404 keep the baskets 102a, 102b in a fixed position relative to the support frame 202a. These locking devices 404 may be “opened” in order to remove a respective basket 102a, 102b from the support frame 202a, such as for removing the baskets 102a, 102b for cleaning (i.e. putting each basket 102a, 102b in a dishwasher; allowing a user to wash each basket 102a, 102b in a dish sink, etc.).

Referring now to FIG. 5, this figure is an elevational, perspective view which illustrates three types of baskets 102a, 102b, 102c which can be combined in various configurations along with two different types of support frames 202a, 202b. Specifically, six different subsystems A, B, C, D, and E have been illustrated in FIG. 5.

The first subsystem A illustrated may comprise a barrel-shaped type basket 102c and a second type of support frame 202b. The barrel-type basket 102c will be described in further detail below. Meanwhile, the support frame 202b for the barrel-shaped type basket 102c of the first subsystem A is a second type of support frame 202b relative to the first type of support frame 202a described above. The differences between the first type of support frame 202a and the second type of support frame 202b may only include differences in length.

Stated differently, the only difference between the first type of support frame 202a and the second type of support frame 202b may be their length dimension, where the first type of support frame 202a may have a first length which is greater than a second length for the second type of support frame 202b. However, other differences are possible and are included within the scope of this disclosure.

For example, the relative thicknesses of members of each support frame 202 may be different when comparing a member from the first support frame 202a to a member from the second support frame 202b. For example, the diameter of shafts 406 in the support frame 202a of the first type, which may be longer than shafts 406 in the support frame 202b of the second type, may have a larger diameter relative to the diameters of the shafts in the support frame 202b of the second type. And vice-versa. Various combinations of dimensioning the two types of support frames 202a, 202b in different ways are possible and are included within the scope of this disclosure. Further details of the support frames 202 will be described below in connection with FIGS. 6-9.

The second subsystem B illustrated in FIG. 5 comprises two smaller baskets 102a (compared to the larger baskets 102b in subsystems C, D, and E) and a support frame 202b of the second type described above. Meanwhile, the third subsystem C illustrated in FIG. 5 comprises a support frame 202b of the second type and a larger basket 102b (relative to the smaller baskets 102a) as described above.

The fourth subsystem C located in the top, far right portion of FIG. 5 comprises a support frame 202a of the first type and three smaller baskets 102a coupled to the support frame 202a. A fifth subsystem D located in the middle, right portion of FIG. 5 comprises a support frame 202a of the first type and two baskets: a larger basket 102b and a smaller basket 102a, both described previously. The fifth subsystem D is also illustrated in prior FIGS. 1-4 as described above.

And the sixth and final subsystem E located in the far, right, bottom portion of FIG. 5 comprises a barrel-shaped type basket 102c and a support frame 202a of the first type. It is noted that other combinations for the baskets 102a, 102b, 102c and support frames 202a, 202b are possible and are included within the scope of this disclosure.

Each type of basket 102a, 102b, and 102c may comprise a locking device 404 as described previously in FIG. 4. While only one locking device 404 is provided for each basket 102a, 102b, 102c, additional locking devices 404 may be employed as understood by one of ordinary skill in the art. Further, while the illustrated placement of each locking device 404 is shown to be the approximate mid-point for a length dimension of a basket 102a, 102b, 102c, other positions for the locking device 404 are possible and are included within the scope of this disclosure.

Referring now to FIG. 6, this figure illustrates an elevational view of a support frame 202a, 202b without any baskets 102a, 102b, 102c coupled to the structure. The support frame 202a, 202b is substantially similar to the support frames 202 previously described in FIGS. 1-5. Therefore, only additional details about the support frame 202a, 202b shown in FIG. 6 will be described here.

The support frame 202a, 202b of FIG. 6 shows the general structure for the support frame 202 of the first and second types. The only differences between the support frames 202 of the first and second type may be the relative dimensions of the central shafts 204a, 204b, side shafts 406a, 406b, and side shaft mounting unit 408. Generally, at least three main differences may exist between the support frames 202a, 202b of the first and second types: the length dimensions Lcs1 of the first central shaft 204a, length dimension Lcs2 of the second central shaft 204b, and the length dimensions Lss of the side shafts 406a, 406b may among the first type and second type may be different relative to each other (relative between the two types).

For a support frame of the first type 202a, the length dimension Lcs1 of the first central shaft 204a may comprise a magnitude between about 4.0 inches to about 6.0 inches. The length dimension Lcs2 of the second central shaft 204b for the first frame type 202a may comprise a magnitude between about 1.0 inch to about 3.0 inches. The length dimension Lss of the two side shafts 406a, 406b for the first frame type 202a may comprise a magnitude between about 8.0 inches to about 12.0 inches.

Generally, the length dimension Lss of the side shaft 406 will correspond to a length dimension or multiple length dimensions and/or a width dimension or multiple width dimensions for the baskets 102a, 102b, 102c (not shown) and may be dependent upon the size and/or orientation of these baskets 102 supported by the side shafts 406 (i.e. See FIG. 5 described above and the various orientations and numbers of baskets 102 held by support frames 202).

Each side shaft 406a, 406b may have a diameter of between about 0.50 of an inch to about 1.0 inch. The square cross-section of the first central shaft 204a may have cross-sectional length between about 0.25 of an inch to about 0.75 of an inch. Meanwhile, the circular cross-section of the short section 402 of the second central shaft 204b may have a diameter between about 0.25 of an inch to about 0.75 of an inch. But other magnitudes for these dimensions below and above these ranges are possible and are included within the scope of this disclosure as understood by one of ordinary skill in the art.

Meanwhile, for the support frame 202b of the second type, the main difference compared to the support frame 202a of the first type is the length dimension Lss of its two side shafts 406a, 406b. For the support frame 202b of the second type, the length dimension Lss of the two side shafts 406a, 406b may comprise a magnitude between about 6.0 inches to about 10.0 inches. However, as noted above, in other exemplary embodiments (not shown) it is also possible to vary the dimensions for the other subsystem elements of the support frame 202b of the second type, such as changing the magnitudes for the dimensions for the Lcs1, Lcs2 and cross-sectional lengths/diameters for the first and second central shafts 204a, 204b.

Additional details of the support frame 202a, 202b are also visible in FIG. 6. Each side shaft mounting unit 408 may comprise a central section 606 and two prismatic arms 604 relative to the central section. Each prismatic arm 604 may further comprise a central cylindrical shaped coupler 602 to match the cross-sectional geometry of a particular side shaft 406.

Specifically, the first side shaft mounting unit 408a of FIG. 6 may comprise a central section 606a which has two prismatic arms 604a, 604b. The central section 606a of the first side shaft mounting unit 408a may be directly coupled to the first central shaft 204a. The first prismatic arm 604a of the first side shaft mounting unit 408a may comprise a first central cylindrical shaped coupler 602a that mates with the first side shaft 406a.

While first coupler 602a may have a cylindrical shape, other shapes are possible especially when/if the cross-sectional shape of the side shafts 406a, 406b are changed. For example, if the cross-sectional shape of the first side shaft 406a was changed to a square shape or a hexagonal shape, then the cross-sectional shape of the coupler 602a would be changed to match the corresponding cross-sectional shape (either square or hexagonal depending on the shape of the side shaft 406). The couplers 602 may hold each side shaft 406 using a press-fit as understood by one of ordinary skill in the art. However, other couplers 602 are possible including couplers 602 with fasteners (not illustrated). Fasteners may include, but are not limited to, screws, nails, rivets, and/or adhesives, and/or any combination thereof.

Other cross-sectional shapes for the coupler 602 and side shafts 406 are possible and are included within the scope of this disclosure as understood by one of ordinary skill in the art. Other shapes include, but are not limited to, triangular, elliptical, pentagonal, octagonal, hexagonal, and other similar polygonal/multi-sided shapes as understood by one of ordinary skill in the art.

Each central shaft 204 and each side shaft 406 may be made of a heat-resistant material, such as, but not limited to, metal and ceramics, and/or any combination thereof. According to one exemplary embodiment, the central shafts 204 and side shafts 406 are made of stainless steel. Each side shaft mounting unit 408 may also be made from a metal and/or a ceramic material or a combination thereof. As a non-limiting example and according to one exemplary embodiment, each side shaft mounting unit 408 is preferably made from aluminum.

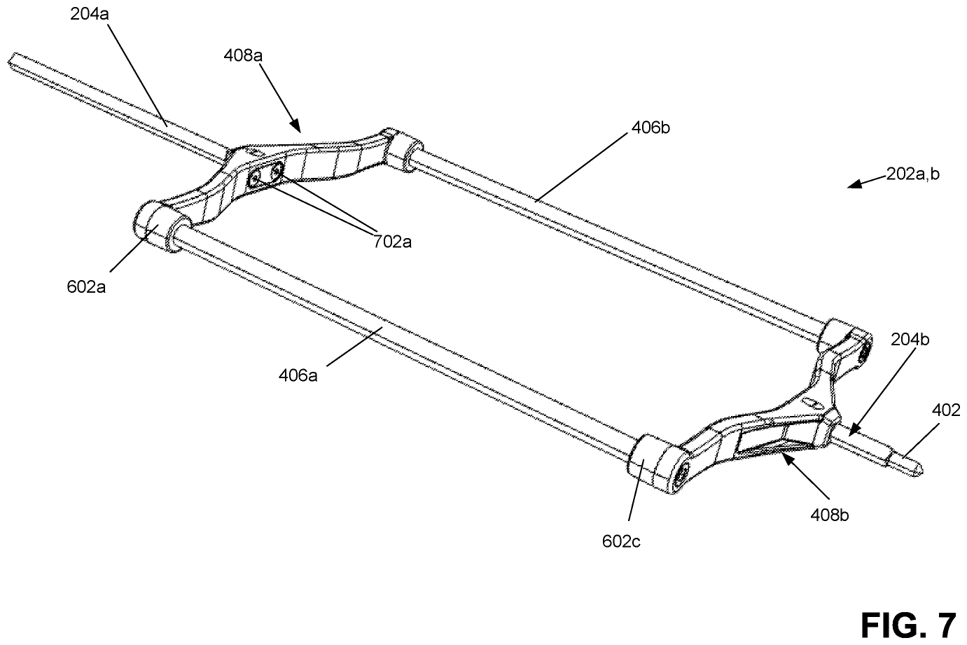

Referring now to FIG. 7, this figure is an elevational, perspective view of the support frame of FIG. 6 according to one exemplary embodiment. In this figure, fasteners 702a which are disposed in the first side shaft mounting unit 408a are visible. The fasteners 702a illustrated may comprise screws. However, other fasteners are possible and are included within the scope of this disclosure. Other fasteners 702 include, but are not limited to, nuts, bolts, rivets, adhesives, and/or any combination thereof.

These fasteners 702a help secure the first central shaft 204a to the side shaft mounting unit 408a. While fasteners 702 are employed, it is possible to couple the first central shaft 204a to the first side shaft mounting unit 408a without fasteners 702a such as using a press-fit, similar to the couplers 602 for the side shafts 406 as described above. The second side shaft mounting unit 408b may have fasteners 702 (not visible in this figure) similar to the fasteners in the first side shaft mounting unit 408a.

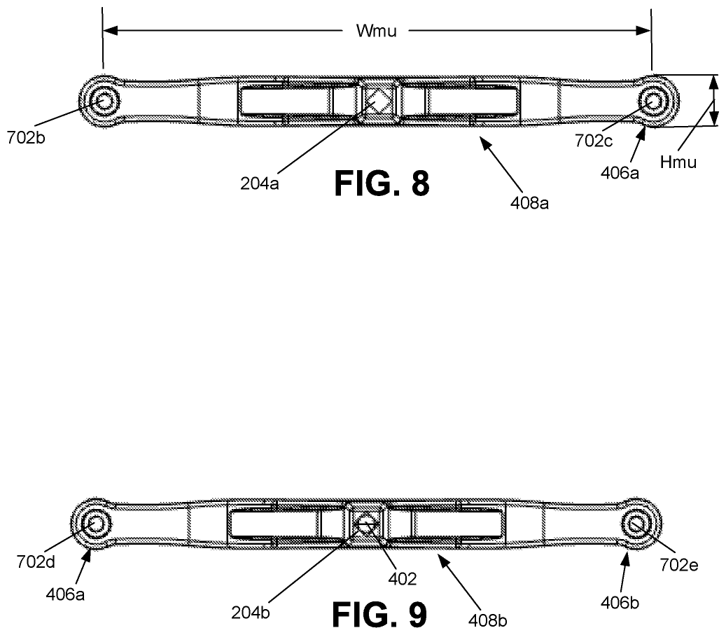

Referring now to FIG. 8, this figure illustrates a side view of the first side shaft mounting 408a unit shown in FIG. 7. Visible in this view are fasteners 702b, 702c for each side shaft 406a, 406b. These fasteners 702b, 702c for the side shafts 406 may be similar for the central shafts 204 described above. The fasteners 702b, 702c may comprise screws, however, as noted above, other fasteners 702 are possible and are included within the scope of this disclosure. Other fasteners 702 include, but are not limited to, nuts, bolts, rivets, adhesives, and/or any combination thereof. While fasteners 702 are employed, it is possible to couple the each side shaft 406 to the first side shaft mounting unit 408a without fasteners 702b, c such as using a press-fit, similar to the couplers 602 for the side shafts 406 as described above.

Also visible in this FIG. 8 is a width dimension Wmu for the mounting unit 408a as well as a height dimension Hmu for the mounting unit 408a. The width dimension Wmu generally corresponds to a length dimension for first two baskets 102a, 102b and a width dimension for the barrel-shaped basket 102c as shown in the earlier figures, such as FIG. 5. The width dimension Wmu for the mounting unit 408a usually has a magnitude between 6.0 inches and 12.0 inches. But other magnitudes for this dimension Wmu below and above this range are possible and are included within the scope of this disclosure as understood by one of ordinary skill in the art.

The height dimension Hmu for the mounting unit 408a generally corresponds/is substantially similar to the diameter of each side shaft 406. The height dimension Hmu for the mounting unit 408a usually has a magnitude between 0.75 of an inch and 1.25 inches. But other magnitudes for this dimension Hmu below and above this range are possible and are included within the scope of this disclosure as understood by one of ordinary skill in the art.

Referring now to FIG. 9, this figure illustrates a side view of the second side shaft mounting unit 408b shown in FIG. 7. The second side shaft mounting unit 408b is substantially identical to the first side shaft mounting unit 408a described above and illustrated in FIGS. 7-8.

As noted previously, and as visible in FIG. 9, the second central shaft 204b may have two different cross-sectional shapes along its length: a square cross-sectional shape for a first portion 204b and a substantially circular cross-section for a short section 402. The circular cross-section at the short section 402 may facilitate ease of rotation at this short section 402 as understood by one of ordinary skill in the art.

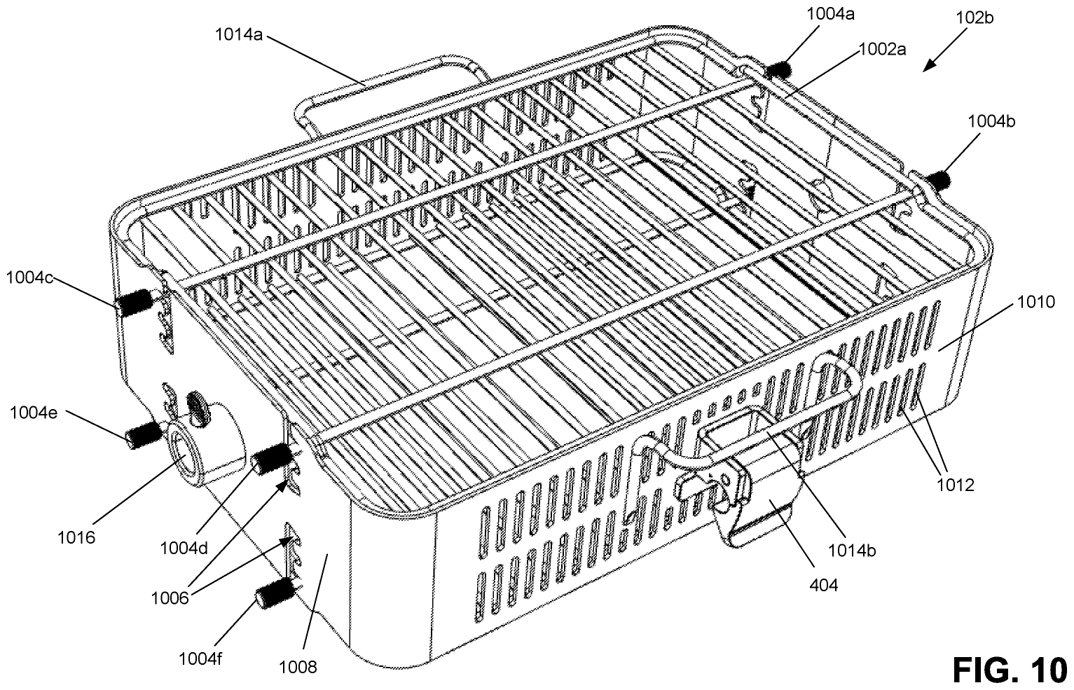

Referring now to FIG. 10, this figure illustrates an elevational, perspective view of the second type of basket 102b which is present in earlier FIGS. 1-5. This second type basket 102b may generally define a rectangular parallelepiped geometry having six sides, where each pair of the three sets of sides are substantially equal in size and shape.

With respect to one set of the sides for the second type of basked 102b, one set of sides may comprise two wire-frame, substantially planar gratings 1002. As shown in FIG. 10, a first grating 1002a is the closest grating 1002 visible in this elevational, perspective view of the second basket type 102b. The individual wires or linear elements of each grating 10002 may comprise a substantially circular cross-section. But other cross-sectional shapes are possible and are included within the scope of this disclosure. Other cross-section shapes include, but are not limited to, triangular, elliptical, square, pentagonal, hexagonal, octagonal, just to name a few. According to the exemplary embodiment illustrated in FIG. 10, each wire element of a grating 1002 may have diameter of about 0.0625 to 0.125 of an inch, but other magnitudes are possible and are included with the scope of this disclosure.

Each grating may include one or more adjustment tabs 1004 which may extend beyond the geometry of the basket 102b for adjusting a relative position of a grating 1002 relative to a pair of short side walls 1008 that define the basket geometry. The adjustment tabs 1004, according to this exemplary embodiment, may comprise portions of wires or linear elements of a grating 1002 which extend outward from the substantially planar geometry formed by the grating 1002. The adjustment tabs 1004 are designed to mate with adjustment grooves 1006 present in each short side wall 1008.

The adjustment grooves 1006 may further comprises one or more notches that are designed to receive the adjustment tabs 1004 of each grating 1002. According to the exemplary embodiment illustrated, three notches are provided. However, additional or fewer notches within each adjustment groove 1006 are possible and are included within the scope of this disclosure. With the notches of the adjustment groove 1006, each grating 1002 may be moved closer within a central portion of the volume formed by the second basket type 102b. This allows each grating 1002 to further compress and/or come in contact with foodstuff, such as meat that could include steaks or fish, which may be thinner relative to the thickness dimension defined by the volume of the second type of basket 102b.

The second type of basket 102b may further comprise two longer side walls 1010 relative to the two shorter side walls 1008. Each longer side wall 1010 may comprise apertures 1012. As illustrated, these apertures 1012 may comprise elongated, elliptical shapes. However, other shapes for the apertures 1012 are possible and are included within the scope of this disclosure. Other shapes include, but are not limited to, rectangular, square, circular, etc. Each side wall 1010 may further comprise a handle 1014 for lifting/positioning the second type of basket 102b from/within the support frame 202 described above.

Each handle 1014 may be fastened to a shorter side wall 1010 by a fastener such as a weld. However, other fasteners for the handles 1014 are possible, and include, screws, nuts, bolts, rivet, adhesives, and/or any combination thereof. For the side wall 1010 most visible in FIG. 10, this sidewall 1010 may further comprise the locking device 406 as described previously in connection with FIG. 4. As noted previously, only one side of each basket 102 may have a locking device 406 which fastens each basket 102 to the support frame 202 as illustrated in FIG. 5 described above.

FIG. 10 further illustrates a spit coupler 1016 positioned on each short side wall 1008. This spit coupler 1016 provides an optional fastening device for connecting the basket 102b directly to a spit if/when a support frame 202 is not being used and/or is not desired for a particular grilling application. The spit coupler 1016 may comprise a cylindrical-shaped sleeve which includes a fastener for penetrating through the sleeve and contacting a spit. The sleeve of the spit coupler 1016 may receive an outer dimeter of a spit (not shown) while the fastener coupled to the sleeve, may penetrate the sleeve and directly contact the spit (not shown).

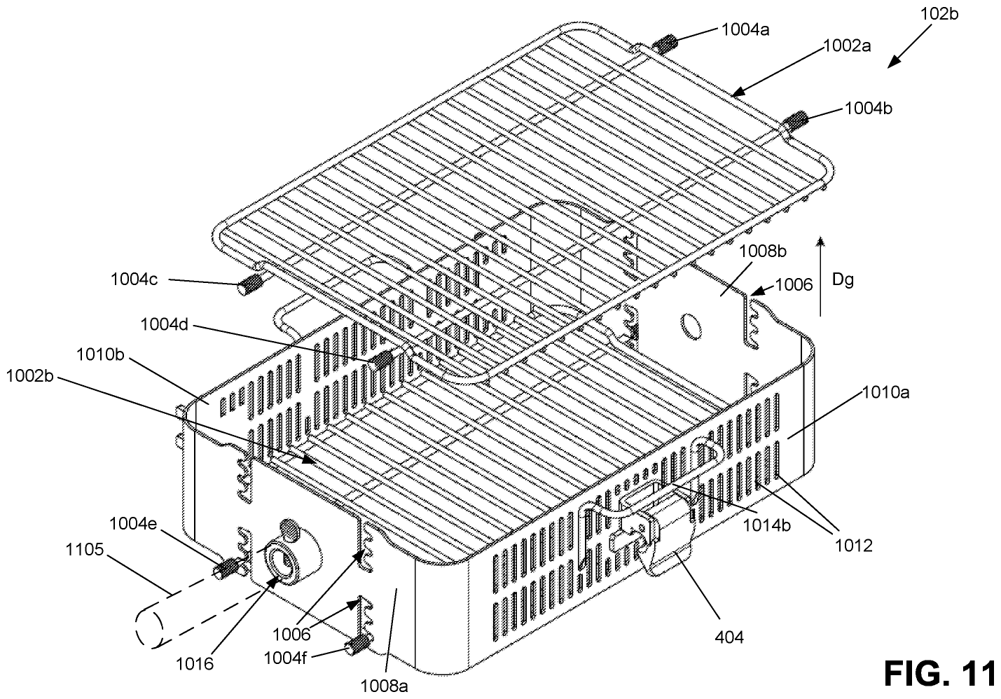

Referring now to FIG. 11, this figure illustrates an elevational, perspective view of the second type of basket 102b also shown in FIG. 10, but with one of the gratings 1002a removed from the side walls 1008, 1010. In this figure, a spit 1105 has been illustrated with dashed lines to show that it is optional. The spit 1105 may couple to the basket 102b via the spit coupler 1016 described above in connection with FIG. 10. As noted previously, spit coupler 1016 may be used when the support frames 202a, 202b are not desired for a particular grilling application.

In this FIG. 11, the first grating 1002a has been removed from the adjustment notches 1006 disposed in the shorter side walls 1008a, 1008b. The first grating 1002a has been moved apart from the basket 102b along directional arrow Dg. With this movement, the second grating 1002b is now more visible relative to FIG. 11. As noted previously, the second grating 1002b also has adjustment tabs 1004 which also mate with the adjustment notches 1006 disposed in the shorter side walls 1008a, 1008b.

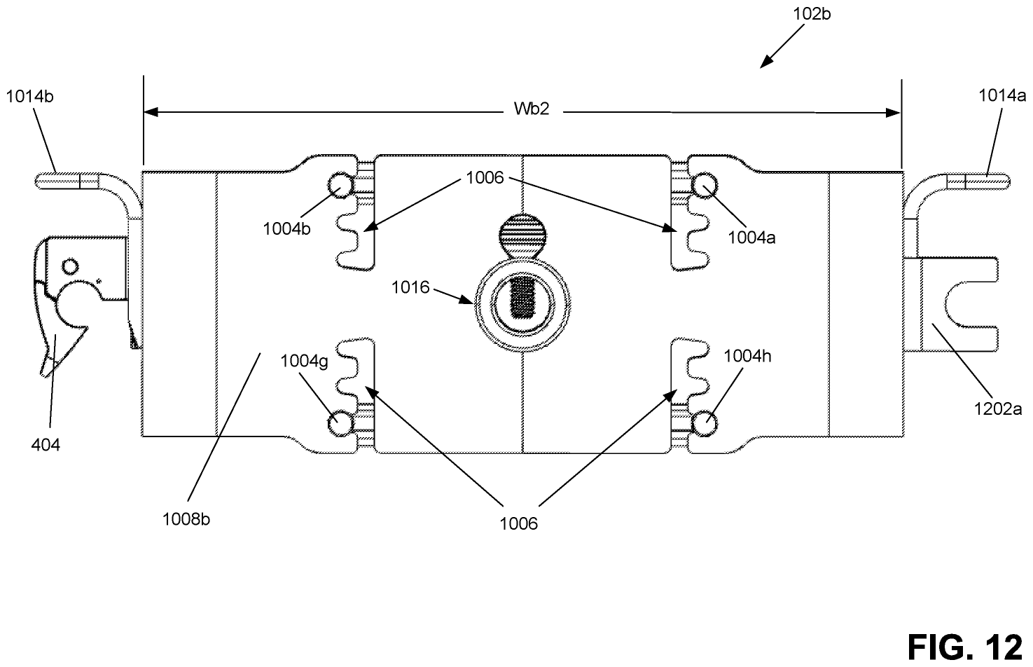

Referring now to FIG. 12, this figure illustrates an side view of the second type of basket 102b shown in FIGS. 10-11. Visible in FIG. 12 is at least one side shaft engagement mechanism 1202a. According to one exemplary embodiment, the side shaft engagement mechanism 1202 may comprise a clamp which has a “C”-shape as shown for engaging with a side shaft 406 (not visible in this figure, but see FIG. 4). Each basket 102 of the three basket types will preferable have at least two side shaft engagement mechanisms 1202 for coupling to one side shaft 406.

The engagement mechanisms 1202 work well with the locking devices 406, such that when the locking device 406 present on one side of the basket is “unlocked” relative to a support frame 202, a particular basket 102 may be easily disengaged from the two side shafts 406 because of the geometry of the engagement mechanism 1202. That is, while the geometry of each engagement mechanism 1202 holds a particular basket 102 in place with the shafts 406 of a support frame 202, a basket 102 may be easily removed from a support frame 202 since the engagement mechanisms 1202 do not “lock-on” to a respective side shaft 406.

FIG. 12 further shows a width dimension Wb2 for this second type of basket 102b. This width dimension Wb2 generally corresponds or is complimentary with respect to the width dimension Wmu of the side shaft mounting units 408 shown in FIG. 8 and described above. The width dimension Wb2 for second basket 102b usually has a magnitude between 6.0 inches and 12.0 inches. But other magnitudes for this width dimension Wb2 below and above this range are possible and are included within the scope of this disclosure as understood by one of ordinary skill in the art.

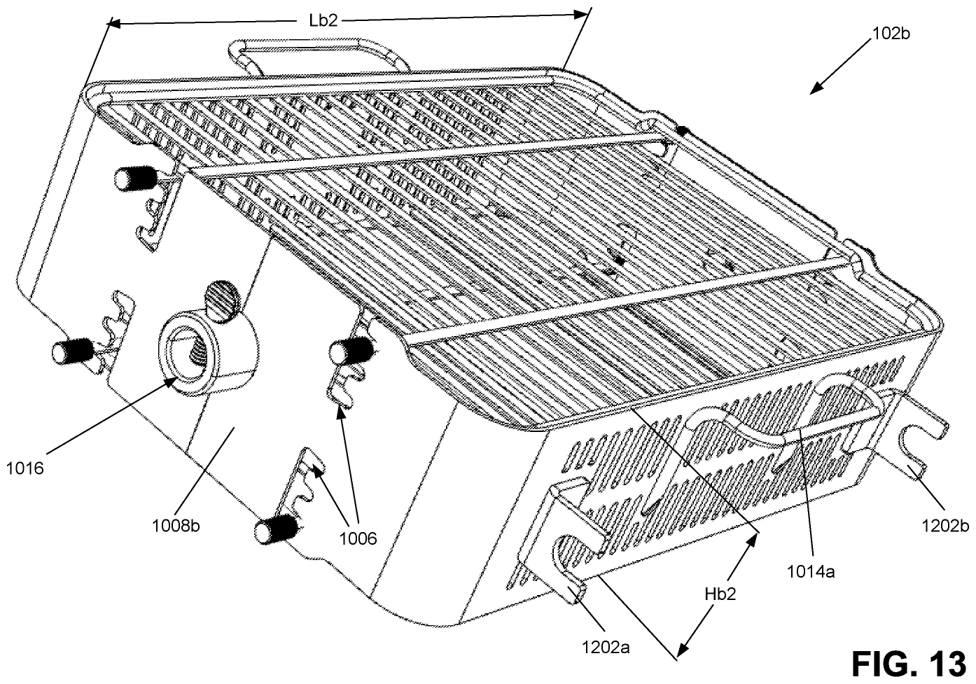

Referring now to FIG. 13, this figure illustrates a side, perspective view of the second type of basket 102b presented in FIGS. 1-5 and 10-12. In this view, the second side shaft engagement mechanism 1202b is visible along with the first side shaft engagement mechanism 1202a. This figure also illustrates that the second basket 102b may have a length dimension Lb2. This length dimension Lb2 generally corresponds or is complimentary with respect to the length dimension Lss of the side shaft 406 shown in FIG. 6 and described above.

The length dimension Lb2 for this second basket 102b usually has a magnitude between about 8.0 inches to about 12.0 inches. But other magnitudes for this length dimension Lb2 below and above this range are possible and are included within the scope of this disclosure as understood by one of ordinary skill in the art.

FIG. 13 further illustrates that second third basket 102b may have a height dimension Hb2. The height dimension Hb2 generally corresponds or is complimentary with respect to the height of the first basket 102a. The height dimension Hb2 for this second basket 102b usually has a magnitude between about 3.0 inches to about 5.0 inches. But other magnitudes for this height dimension Hb2 below and above this range are possible and are included within the scope of this disclosure as understood by one of ordinary skill in the art.

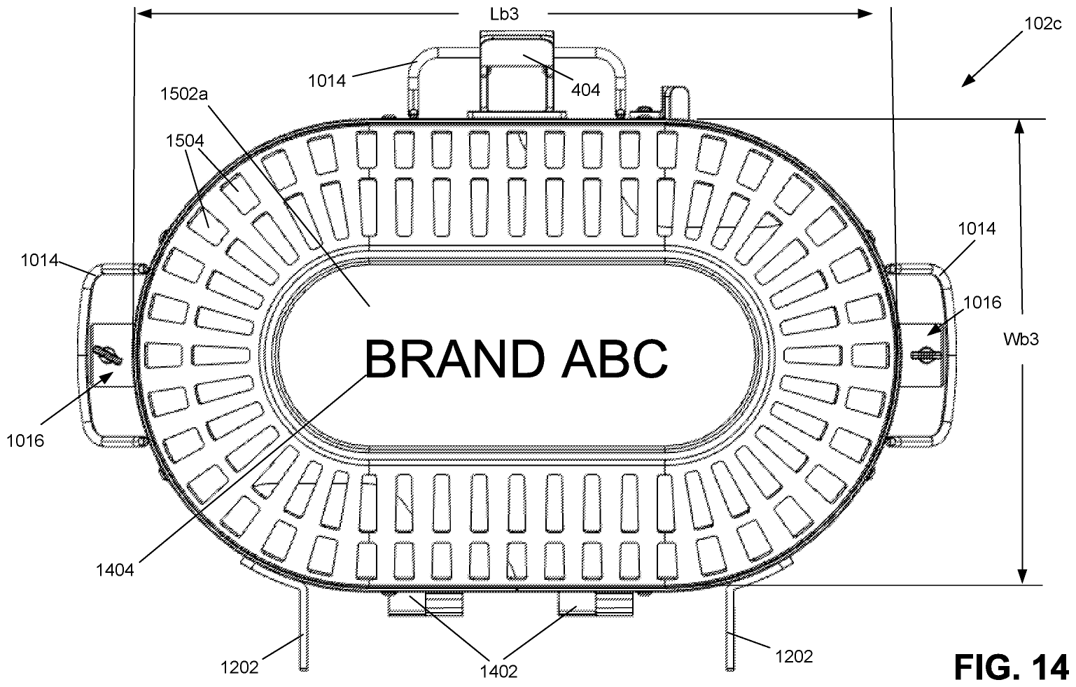

Referring now to FIG. 14, this figure illustrates a top view of a basket 102c of the third type as also shown in FIG. 5. This third type of basket 102c shares common features with the other two baskets of the first type (102a) and the second type (102b) mentioned above. Exemplary common features include, but are not limited to, the locking device 406, handles 1014, spit couplers 1016, and side shaft engagement mechanisms 1202. Details of these common features will not be describe here since they were described previously above.

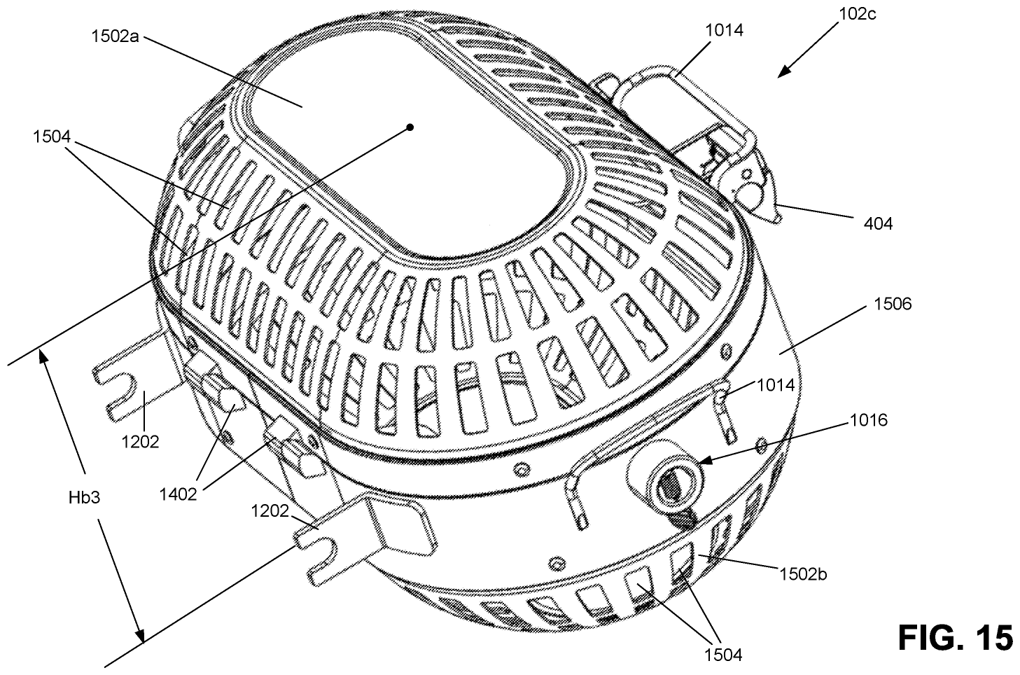

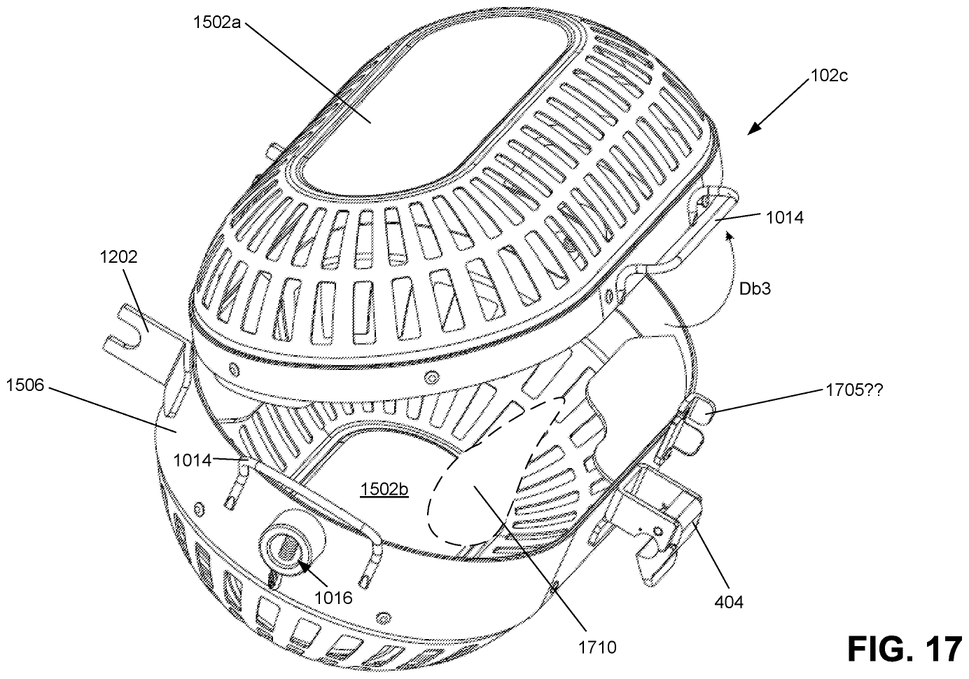

FIG. 14 further illustrates that the third basket 102c may comprise two hinge mechanisms 1402. The hinge mechanisms 1402 allow a first half 1502a of the third basket 102c to be opened relative to a second half 1502b (not visible, but see FIGS. 15-17) of the third basket 102c. Operation of the hinge mechanisms 1402 are further illustrated in FIG. 17 described below.

FIG. 14 further illustrates that the first half 1502a of the third basket 102c may comprise one-half of a clam-shell-like structure/geometry. Each half 1502 of the third basket 102c may further comprise apertures 1504 along a periphery of the shape of each half 1502. Each half 1502 may also have a surface that can support a brand 1404 as shown in FIG. 14. The brand or brand area/region 1404 may comprise alpha-numeric text as well as graphical symbols and/or illustrations as understood by one of ordinary skill in the art.

FIG. 14 further illustrates that this third basket 102c may have a length dimension Lb3 and a width dimension Wb3. The length dimension Lb3 generally corresponds or is complimentary with respect to the length dimension Lss of the side shaft 406 shown in FIG. 6 and described above. The length dimension Lb3 for this third basket 102c usually has a magnitude between about 8.0 inches to about 12.0 inches. But other magnitudes for this length dimension Lb3 below and above this range are possible and are included within the scope of this disclosure as understood by one of ordinary skill in the art.

Similarly, the width dimension Wb3 of the third basket 102c may generally correspond or is complimentary with respect to the width dimension Wmu of the side shaft mounting unit 408 shown in FIG. 8 and described above. The width dimension Wmu for this third basket 102c usually has a magnitude between about 6.0 inches and 12.0 inches. But other magnitudes for this width dimension Wb3 below and above this range are possible and are included within the scope of this disclosure as understood by one of ordinary skill in the art.

Referring now to FIG. 15, this figure illustrates a perspective, side view of the third basket 102c that is illustrated in FIGS. 5 and 14. In this FIG. 15, the third basket 102 may further comprise a continuous, central wall 1506 that mates with each half 1502a, 1502b. This central wall 1506 may support the spit couplers 106 as well as the locking device 406, handles 1016, side shaft engagement mechanisms 1202, and the hinges 1402. Usually, the central wall 1506 does not have any apertures 1504, such as those found in each half 1502a, 1502b. However, variations of the central wall 1506 are possible, so it is possible that other exemplary embodiments for central wall 1506 could be provided with apertures 1504 (not illustrated).

The central wall 1506 in combination with the clam-shell-like halves 1502a, 1502b may form an overall “barrel”-like/“barrel-looking” geometry due to the curved geometry of the two halves 1502a, 1502b and the thickness dimension of the central wall 1506. Like the first and second baskets 102a, 102b described above, the third basket 102c illustrated in FIG. 15 may enclose/envelope/contain foodstuff, such as meat, that may include, but is not limited to, beef, pork, venison, and/or fish, and any combination thereof.

FIG. 15 further illustrates a height dimension Hb3 for this third basket 102c. Similarly, this height dimension Hb3 of the third basket 102c usually has a magnitude between about 6.0 inches and 10.0 inches. But other magnitudes for this height dimension Hb3 below and above this range are possible and are included within the scope of this disclosure as understood by one of ordinary skill in the art.

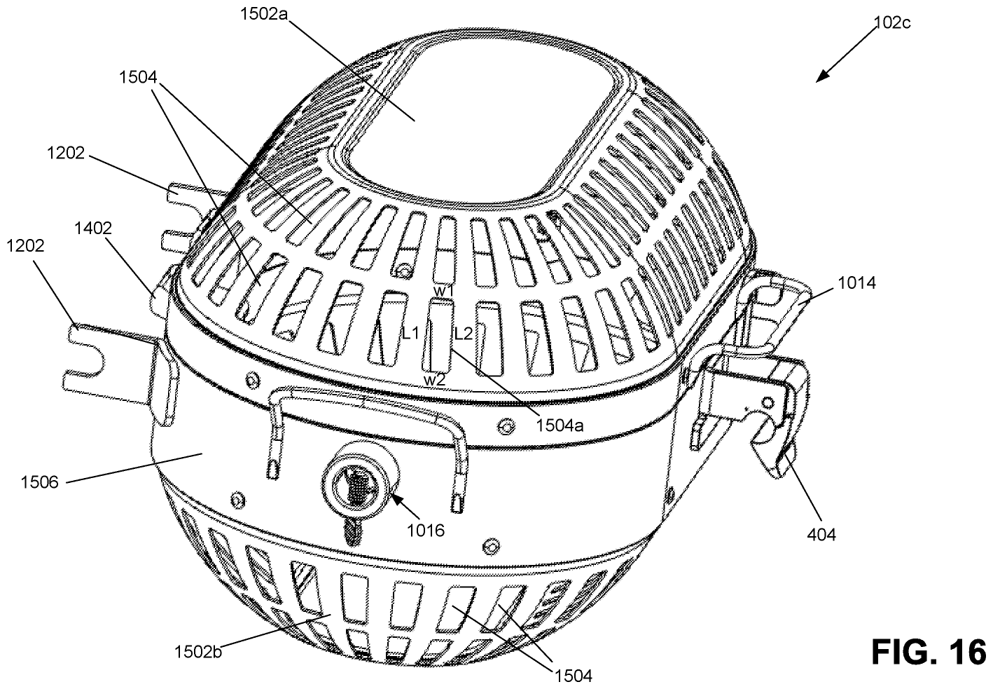

Referring now to FIG. 16, this figure illustrates a side, perspective view of the third basket 102c slightly rotated relative to the orientation illustrated in FIG. 15. In this FIG. 15, the locking device 406 for the third basket 102c is more visible. The apertures 1504 of each half 1502a, 1502b generally have a modified rectangular geometry. Specifically, the modified rectangular geometry may be described in connection with a selected aperture 1504a.

Aperture 1504 a includes two short sides w1, w2 and two long sides L1, L2. A first side w1 of the two short sides generally has a first width dimension, while a second w2 of the two short sides has a second width dimension greater than the width of the first side w1. In this way, long sides L1, L2 curve/bend when following the long sides L1, L2 extending from the first short side w2 to the second short side w1.

Referring now to FIG. 17, this figure illustrates a side, perspective view of the third basket where its top half/clam shell 1502a has been opened along the hinges 1402 which were illustrated in FIG. 15. In this FIG. 17, the top half 1502a has been opened in the direction of directional arrow Db3 so that the third basket 102c may be loaded and/or unloaded. An exemplary foodstuff 1710 is illustrated as positioned within the volume defined by the geometry of the third basket 102b. Element 1705 is a latch to keep the lid closed during use.

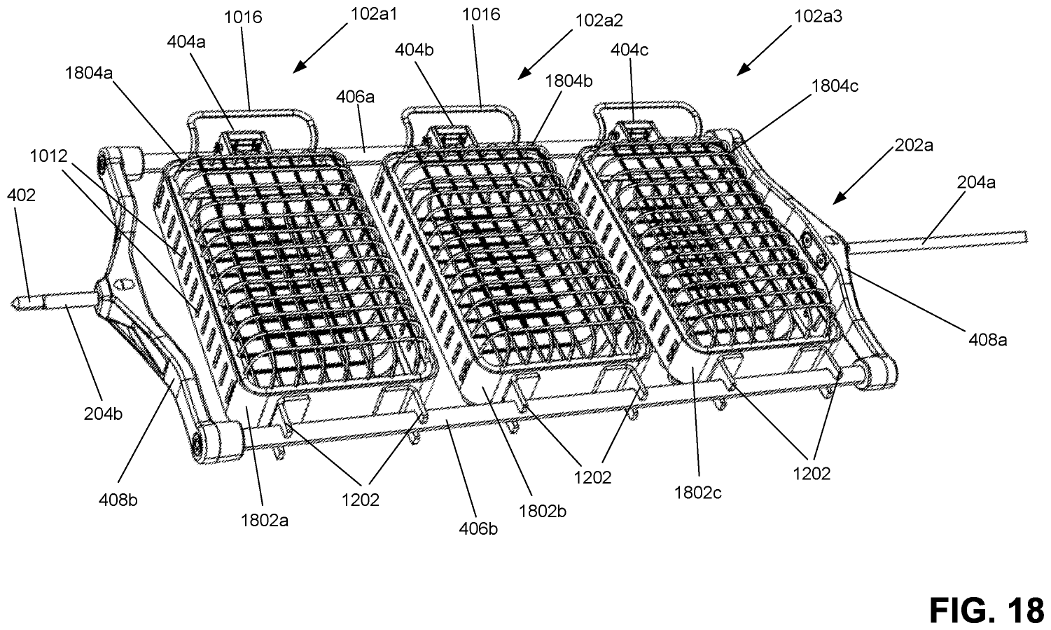

Referring now to FIG. 18, this figure illustrates an elevational perspective view of three baskets 102a1, 102a2, 102a3 of the first type which are also illustrated in FIG. 5. In this FIG. 18, each basket 102a has two gratings 1804 and a single, continuous side wall 1802. The side wall 1802 may further comprise apertures 1012 similar to the other apertures 1012 described previously.

Three of these baskets 102a of the first type may fit or be coupled to a single support frame 202a as illustrated. The baskets 102a may further comprise similar elements of the baskets 102b, 102c of the second and third types described above. Specifically, the first baskets 102a may also comprise locking mechanisms 404 and side bar engagement mechanisms 1202.

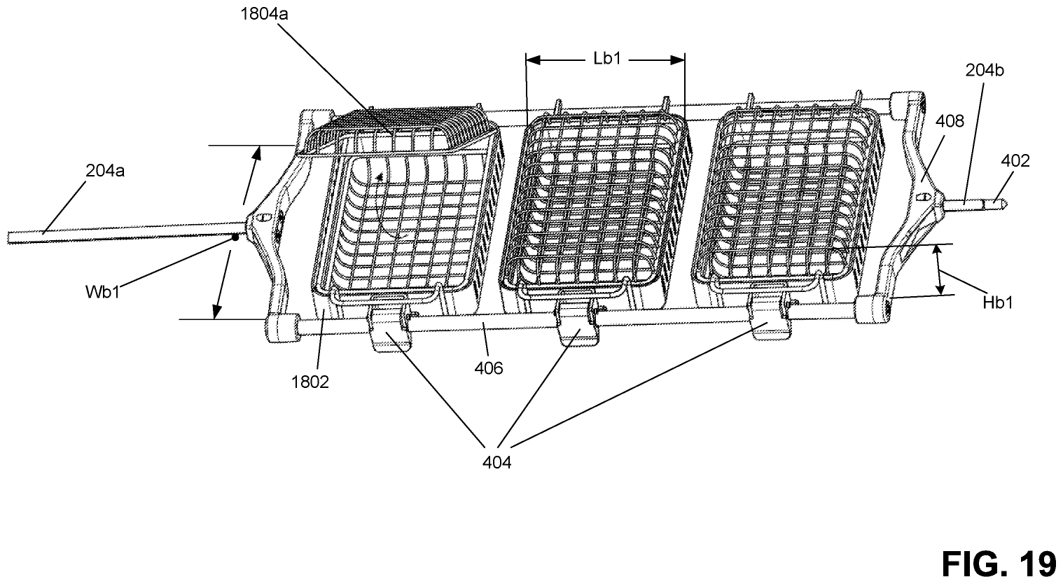

Referring now to FIG. 19, this figure illustrates another perspective, elevational view of the three baskets 102a of the first type of FIG. 18, where a grating 1804a of one basket 102a1 has been opened. FIG. 19 further illustrates a length dimension Lb1, a width dimension Wb1, and a height dimension Hb1. The length dimension Lb1 generally corresponds or is complimentary with respect to the length dimension Lss of the side shaft 406 shown in FIG. 6 and described above.

The length dimension Lb1 for this first basket 102a usually has a magnitude between about 3.0 inches to about 4.0 inches. But other magnitudes for this length dimension Lb1 below and above this range are possible and are included within the scope of this disclosure as understood by one of ordinary skill in the art.

Similarly, the width dimension Wb1 of the first basket 102a may generally correspond or is complimentary with respect to the width dimension Wmu of the side shaft mounting unit 408 shown in FIG. 8 and described above. The width dimension Wb1 for this first basket 102a usually has a magnitude between about 6.0 inches and 12.0 inches. But other magnitudes for this width dimension Wb1 below and above this range are possible and are included within the scope of this disclosure as understood by one of ordinary skill in the art.

Also illustrated in FIG. 19 is a height dimension Hb1 for the first baskets 102. This height dimension Hb1 for this first basket 102 usually has a magnitude between about 2.0 inches and 4.0 inches. But other magnitudes for this height dimension Hb1 below and above this range are possible and are included within the scope of this disclosure as understood by one of ordinary skill in the art.

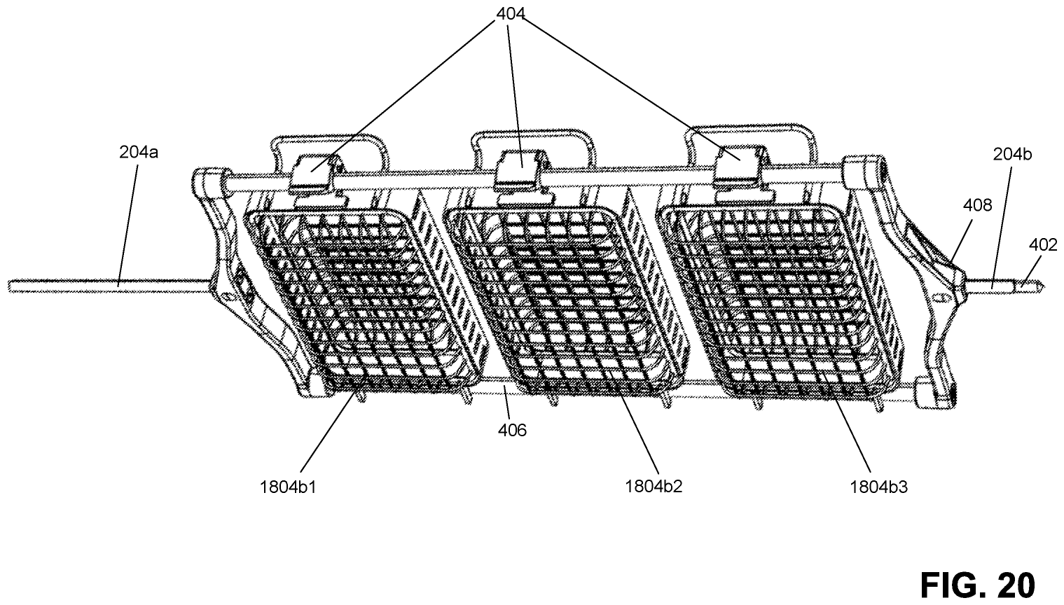

Referring now to FIG. 20, this figure illustrates a bottom, perspective view of the three baskets 102a of the first type which have been slightly rotated along the central shaft 204 relative to the position of the three baskets shown in FIG. 19. In this FIG. 19, the bottom gratings 1804b1, 1804b2, and 1804b3 are now more fully visible relative to the exemplary embodiments shown in FIGS. 18-19. Each of the first baskets 102 may be secured to side shafts 406 with the locking devices 404 which were described previously. The grating 1804 may be coupled or connected or joined to the side wall 1802 via hinges or a clip mechanism, although other means for coupling the grating 1804 to the sidewall 1802 are envisioned and will occur to those with skill in the art.

Although a few embodiments have been described in detail above, those skilled in the art will readily appreciate that many modifications are possible in the embodiments without materially departing from this disclosure. Accordingly, such modifications are intended to be included within the scope of this disclosure as defined in the following claims. In the claims, means-plus-function clauses are intended to cover the structures described herein as performing the recited function and not only structural equivalents, but also equivalent structures.

Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, sixth paragraph for any limitations of any of the claims herein, except for those in which the claim expressly uses the words ‘means for’ together with an associated function.

Therefore, although selected aspects have been illustrated and described in detail, it will be understood that various substitutions and alterations may be made therein without departing from the spirit and scope of the present invention, as defined by the following claims.

What is claimed is:

1. A system for improving rotisserie grilling applications, comprising:
a support frame comprising at least one central shaft, a first side shaft, and a second side shaft;
a basket coupled to the two side shafts, the basket comprising a locking device that couples to the first side shaft and a side shaft engagement mechanism that couples to the second side shaft, the basket defining a volume for receiving foodstuff.

2. The system of claim 1, wherein the side shaft engagement mechanism comprises a clamp.

3. The system of claim 2, wherein the support frame further comprises a side shaft mounting unit that receives the one central shaft within a central portion.

4. The system of claim 1, wherein the basket is a first basket, the system further comprising a second basket that is positioned along the support frame adjacent to the first basket.

5. The system of claim 6, wherein the first and second baskets have different geometries relative to each other.

6. The system of claim 6, wherein the first and second baskets have substantially identical geometries relative to each other.

7. The system of claim 1, wherein the basket comprises an adjustable grating.

8. The system of claim 1, wherein the basket defines a barrel-shape geometry.

9. The system of claim 1, wherein the basket has a wire-frame grating that is removable.

10. A system for improving rotisserie grilling applications, comprising:
a support frame comprising at least one central shaft, a first side shaft, and a second side shaft;
a basket coupled to the two side shafts, the basket comprising a locking device that couples to the first side shaft and a side shaft engagement mechanism that couples to the second side shaft, the basket defining a volume for receiving foodstuff, wherein the side shaft engagement mechanism comprises a c-shaped clamp.

11. The system of claim 10, wherein the support frame further comprises a side shaft mounting unit that receives the one central shaft within a central portion.

12. The system of claim 10, wherein the basket is a first basket, the system further comprising a second basket that is positioned along the support frame adjacent to the first basket.

13. The system of claim 12, wherein the first and second baskets have different geometries relative to each other.

14. The system of claim 12, wherein the first and second baskets have substantially identical geometries relative to each other.

15. A system for improving rotisserie grilling applications, comprising:
a support frame comprising at least one central shaft, a first side shaft, and a second side shaft, wherein the support frame further comprises a side shaft mounting unit that receives the one central shaft within a central portion and is coupled to a first end of the first side shaft and a first end of the second side shaft;
a basket coupled to the two side shafts, the basket comprising a locking device that couples to the first side shaft and a side shaft engagement mechanism that couples to the second side shaft, the basket defining a volume for receiving foodstuff.

16. The system of claim 15, wherein the basket is a first basket, the system further comprising a second basket that is positioned along the support frame adjacent to the first basket.

17. The system of claim 16, wherein the first and second baskets have different geometries relative to each other.

18. The system of claim 16, wherein the first and second baskets have substantially identical geometries relative to each other.

19. The system of claim 15, wherein the basket defines a barrel-shape geometry.

20. The system of claim 15, wherein the basket has a wire-frame grating that is removable.
